(19) United States
(12) Patent Application Publication
(10) Pub. No.: US 2025/0077864 A1
(43) Pub. Date: Mar. 6, 2025

(54) METHOD FOR TRAINING A MACHINE LEARNING MODEL FOR GENERATING DESCRIPTOR IMAGES FOR IMAGES SHOWING ONE OR MORE OBJECTS

(71) Applicant: Robert Bosch GmbH, Stuttgart (DE)

(72) Inventors: David Adrian, Stuttgart (DE); Andras Gabor Kupcsik, Herrenberg (DE); Markus Spies, Karlsruhe (DE)

(21) Appl. No.: 18/816,163

(22) Filed: Aug. 27, 2024

(30) Foreign Application Priority Data
Sep. 6, 2023 (DE) 10 2023 208 619.0

(51) Int. Cl. G06N 3/08

(52) U.S. Cl. CPC G06N 3/08

(57) ABSTRACT

A method for training a machine learning model for generating descriptor images. The method includes recording a plurality of camera images, forming training image pairs from the plurality of camera images, wherein each training image pair includes a first training image and a second training image, ascertaining a loss for the training image pair and at least one key point from a distance between the position of the key point in the first training image or a transformed version of the first training image and an estimated position of the key point, which is ascertained by transitioning from the first training image to the second training image and back to the first training image or its transformed version, and adapting the machine learning model for reducing a total loss that includes the ascertained losses for at least a part of the training image pairs and key points.

### CROSS REFERENCE

The present application claims the benefit under 35 U.S.C. § 119 of German Patent Application No. DE 10 2023 208 619.0 filed on Sep. 6, 2023, which is expressly incorporated herein by reference in its entirety.

### FIELD

The present invention relates to methods for training a machine learning model for generating descriptor images for images showing one or more objects.

### BACKGROUND INFORMATION

In order to allow for flexible production or processing of objects by a robot, it is desirable for the robot to be capable of handling an object regardless of the position in which the object is placed in the workspace of the robot. Therefore, the robot should be able to recognize which parts of the object are in which positions so that it can, for example, grasp the object in the correct location in order to fasten or weld it to another object. This means that the robot should be able to recognize the pose (position and orientation) of the object, for example from one or more images recorded by a camera fastened to the robot, or to ascertain the position of locations for recording or processing. One approach for achieving this is to determine descriptors, i.e., points (vectors) in a predefined descriptor space, for parts of the object (i.e., pixels of the object represented in an image plane), wherein the robot is trained to allocate the same descriptors to the same parts of an object regardless of a current pose of the object and thus to recognize the topology of the object in the image, so that it is then known, for example, where which corner of the object is located in the image. If the pose of the camera is known, the pose of the object can then be deduced. The recognition of the topology can be achieved with a machine learning model that is trained accordingly.

Approaches for efficient training of such a machine learning model are desirable.

### SUMMARY

According to various example embodiments of the present invention, a method for training a machine learning model for generating descriptor images for images showing one or more objects is provided, comprising:
recording a plurality of camera images, wherein each camera image shows one or more objects,
forming training image pairs from the plurality of camera images, wherein each training image pair has a first training image and a second training image,
for each training image pair and for each of one or more key points per training image pair (which is/are included in at least the first training image)
   generating a first descriptor image for the first training image by feeding the first training image to the machine learning model (wherein the first descriptor image includes for each point of the first training image a relevant descriptor (which the machine learning model assigns to it based on the first training image));
   generating a second descriptor image for the second training image by feeding the second training image to the machine learning model (wherein the second descriptor image includes for each point of the second training image a relevant descriptor (which the machine learning model assigns to it based on the second training image));
   ascertaining the descriptor included in the first descriptor image for the key point (e.g., object feature point or point in the background);
   estimating, for each of the plurality of points of the second training image (e.g., all), a probability that the point corresponds to the key point (i.e., shows the same object feature point or point in the background), wherein the probability is estimated to be greater the closer the descriptor included in the first descriptor image for the key point is to the descriptor included in the second descriptor image for the relevant point of the second training image of the plurality of points of the second training image;
   estimating a descriptor that the second descriptor image would include for the key point (if it actually includes the estimated descriptor for one of the points, which is not necessarily the case), by weighted sum of the descriptors that the second descriptor image includes for the plurality of points of the second training image, wherein each descriptor is weighted by the probability ascertained for the point for which it is included in the second descriptor image;
   estimating the position of a point in the first training image or a transformed version of the first training image to which the machine learning model would assign the estimated descriptor (if it actually assigns the estimated descriptor for one of the points, which is not necessarily the case); and
   ascertaining a loss for the training image pair and the key point from a distance between the position of the key point in the first training image or the transformed version of the first training image and the estimated position; and
adapting the machine learning model for reducing a total loss (e.g., batch loss) that includes the ascertained losses for at least a part of the training image pairs and key points.

The method described above enables a simplified training data collection and accordingly a less complex training of a machine learning model for generating descriptor images compared to, for example, methods that require RGB-D image sequences, 3D reconstructions or other ground truth annotation approaches. The use of a loss for self-supervised training according to the method described above allows for a training by means of unordered RGB images or even pairs of different images (i.e., different recordings and not just augmentations of the same image). Correspondences of points between various images are automatically ascertained by means of a “cycle” (transition from the first image to the second image and back again).

Various exemplary embodiments of the present invention are specified below.

Exemplary embodiment 1 is a method for training a machine learning model for generating descriptor images for images, as described above.

Exemplary embodiment 2 is the method according to exemplary embodiment 1, wherein the position of the point in the first training image or in the transformed version of the first training image is estimated by estimating, for each of a plurality of points in the first training image or in the transformed version of the first training image (e.g., for all points), a probability that the point corresponds to a point to which the machine learning model would assign the estimated descriptor (if it actually assigns the estimated descriptor to one of the points, which is not necessarily the case), wherein the probability is estimated to be greater the closer the estimated descriptor is to the descriptor that the machine learning model assigns to the relevant point of the plurality of points in the first training image or the transformed version of the first training image, and each coordinate of the position of the point is estimated as a weighted sum of the values of the coordinates of the plurality of points in the first training image or the transformed version of the first training image, wherein each value of the coordinate is weighted with the probability ascertained for the point whose position it describes (see equations (3) and (4) below).

In other words, the “backward direction” of the cycle (i.e., the transition from the second image to the first image) is carried out analogously to the transition of the “forward direction” of the cycle (i.e., the transition from the first image to the second image) via probabilities, so that no hard selection is carried out in the correspondence ascertainment and thus differentiability is ensured, which enables the use of gradient descent methods for training.

Exemplary embodiment 3 is the method according to exemplary embodiment 1 or 2, wherein the total loss for each training image pair for which the loss is ascertained for each of a plurality of key points includes the losses ascertained for the key points as a weighted sum, wherein each ascertained loss is weighted less the greater a measure of the variance of the estimate of the position of the point in the first training image or in the transformed version of the first training image to which the machine learning model would assign the estimated descriptor and/or the estimate of the position of the point in the second training image to which the machine learning model would assign the estimated descriptor is when ascertaining the loss for the relevant key point.

As a result, it avoids a key point that is not present (i.e., shown) in the second training image leading to a loss that degrades the training.

Exemplary embodiment 4 is the method according to exemplary embodiment 3, wherein the ascertained loss in the total loss is weighted with zero if the measure of variance is above a threshold value.

Thus, the training from particularly unreliable correspondence ascertainments is protected. For example, the threshold value is ascertained in such a way that ascertained losses that belong to a certain quantile (e.g., 15% quantile) with regard to their value for the measure of variance are not taken into account in the total loss.

Exemplary embodiment 5 is the method according to one of exemplary embodiments 1 to 4, wherein the transformed version of the first training image is generated by an augmentation of the first training image or wherein the forming of at least some of the training image pairs comprises that the first training image is generated by augmenting a relevant recorded camera image and wherein the transformed version of the first training image is generated by another augmentation of the relevant recorded camera image.

Thus, it can be avoided (using the transformed version for the “backward direction”) that the machine learning model learns “shortcuts” (without correspondence to the second training image).

Exemplary embodiment 6 is the method according to one of exemplary embodiments 1 to 5, wherein the machine learning model is a neural network.

According to various embodiments, for example, a dense object net is trained. With these, good results can be achieved for generating descriptor images.

Exemplary embodiment 7 is a method for controlling a robot to record or process an object, comprising training a machine learning model according to one of exemplary embodiments 1 to 6, recording a camera image that shows the object in a current control scenario, feeding the camera image to the machine learning model for generating a descriptor image, ascertaining the position of a location for recording or processing the object in the current control scenario from the descriptor image; and controlling the robot according to the ascertained position.

Exemplary embodiment 8 is the method according to exemplary embodiment 7, comprising identifying a reference location in a reference image, ascertaining a descriptor of the identified reference location by feeding the reference image to the machine learning model, ascertaining the position of the reference location in the current control scenario by searching for the ascertained descriptor in the descriptor image generated from the camera image, and ascertaining the position of the location for recording or processing the object in the current control scenario from the ascertained position of the reference location.

Exemplary embodiment 9 is a control device that is configured to carry out a method according to one of exemplary embodiments 1 to 8.

Exemplary embodiment 10 is a computer program comprising commands which, when executed by a processor, cause the processor to carry out a method according to one of exemplary embodiments 1 to 8.

Exemplary embodiment 11 is a computer-readable medium storing commands which, when executed by a processor, cause the processor to carry out a method according to one of exemplary embodiments 1 to 8.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a robot, according to an example embodiment of the present invention.

FIG. 2 illustrates a cycle of correspondence predictions for a key point, according to an example embodiment of the present invention.

FIG. 3 shows a flow chart that illustrates a method for training a machine learning model for generating descriptor images to images showing one or more objects, according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of the present invention. The various aspects of this disclosure are not necessarily mutually exclusive, since some aspects of this disclosure may be combined with one or more other aspects of this disclosure to form new aspects.

Various examples are described in more detail below.

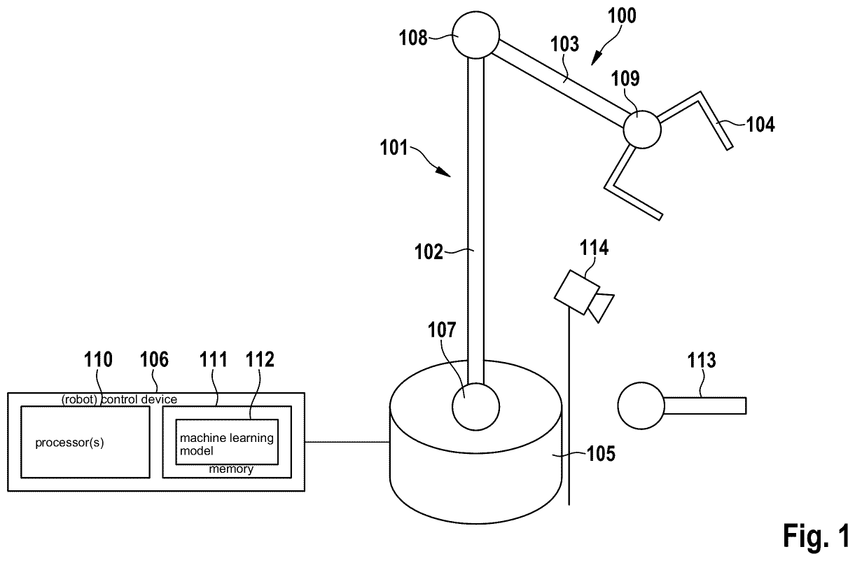

FIG. 1 shows a robot 100.

The robot 100 includes a robot arm 101, for example an industrial robot arm for handling or assembling a work piece (or one or more other objects). The robot arm 101 includes manipulators 102, 103, 104 and a base (or support) 105 by means of which the manipulators 102, 103, 104 are supported. The term “manipulator” refers to the movable components of the robot arm 101, the actuation of which enables physical interaction with the environment, e.g., to execute a task. For control, the robot 100 includes a (robot) control device 106, which is designed to implement the interaction with the environment according to a control program. The last component 104 (which is farthest away from the support 105) of the manipulators 102, 103, 104 is also referred to as the end effector 104 and may include one or more tools such as a welding torch, a gripping instrument, a painting apparatus or the like.

The other manipulators 102, 103 (located closer to the support 105) may form a positioning apparatus so that, together with the end effector 104, the robot arm 101 is provided with the end effector 104 at its end. The robot arm 101 is a mechanical arm that can provide similar functions to a human arm (possibly with a tool at its end).

The robot arm 101 may include joint elements 107, 108, 109 that connect the manipulators 102, 103, 104 to each other and to the support 105. A joint element 107, 108, 109 may have one or more joints that may each provide a rotatable movement (i.e., rotational movement) and/or translational movement (i.e., displacement) for associated manipulators relative to each other. The movement of the manipulators 102, 103, 104 can be initiated by means of actuators which are controlled by the control device 106.

The term “actuator” may be understood as a component that is designed to bring about a mechanism or process in response to its drive. The actuator can implement instructions (called activation) generated by the control device 106 as mechanical movements. The actuator, for example, an electromechanical converter, can be designed to convert electrical energy into mechanical energy in response to its drive.

The term “control device” may be understood as any type of logic-implementing entity that can include, for example, a circuit and/or processor that is capable of executing software, firmware or a combination thereof stored in a storage medium, and that may issue instructions, e.g., to an actuator in the present example. The control device can be configured for example by program code (e.g., software) to control the operation of a system, in the present example a robot.

In the present example, the control device 106 includes one or more processors 110 and a memory 111 that stores code and data, on the basis of which the processor 110 controls the robot arm 101. According to various embodiments, the control device 106 controls the robot arm 101 based on a machine learning model 112 stored in the memory 111.

The control device 106 uses the machine learning model 112 in order to ascertain the pose of an object 113 that is placed, for example, in a workspace of the robot arm 101. Depending on the ascertained pose, the control device 106 can, for example, decide which location of the object 113 should be gripped (or otherwise processed) by the end effector 109.

The control device 106 ascertains the pose using the machine learning model 112 using one or more camera images of the object 113. The robot 100 can, for example, be equipped with one or more cameras 114 that enable it to record images of its workspace. A camera 114 is fastened to the robot arm 101, for example, so that the robot can record images of the object 113 from various perspectives by moving the robot arm 101. However, one or more fixed cameras can also be provided.

According to various embodiments, the machine learning model 112 is a (deep) neural network that generates a feature map for a camera image, e.g., in the form of an image in a feature space, which allows for assigning points in the (2D) camera image to points of the (3D) object.

For example, the machine learning model 112 can be trained to allocate a certain (unique) feature value (also referred to as a descriptor value) in the feature space to a certain corner of the object. If a camera image is then fed to the machine learning model 112 and the machine learning model 112 assigns this feature value to a point in the camera image, it can be concluded that the corner is located at this location (i.e., at a location in space, the projection of which onto the camera plane corresponds to the point in the camera image). If you know the position of a plurality of points of the object in the camera image, one can ascertain the pose of the object in space.

The machine learning model 112 must be suitably trained for this task.

An example of a machine learning model 112 for object recognition is a dense object net (DON). A dense object net forms an image (e.g., an RGB image provided by the camera 114 I∈ [symbol] ^{H×W×3}) to an arbitrarily dimensional (with user-defined dimension D, e.g., D=16) descriptor space image (also referred to as a descriptor image) I_{D}∈ [symbol] ^{H×W×D}, i.e., each pixel is allocated a descriptor value.

Such dense visual descriptors have been proven to provide a flexible, easy-to-use and easy-to-learn object representation for robot manipulation. They show potential for generalizing objects at class level, they can describe non-rigid objects and they can be used seamlessly for state representation for control.

Training a dense descriptor network can be performed with the aid of self-supervision, which relies on a plurality of views of the same object and dense pixel correspondence that is calculated from the 3D geometry of the object. Alternatively, RGB image augmentations can be used to generate alternative views of the same image, wherein pixel correspondence is tracked. These two approaches only differ in how pixel correspondences between a plurality of images are generated and what assumption they have for the training dataset; otherwise, the same loss function, e.g., contrastive losses, can be applied.

Training by means of pixel correspondence calculated by 3D geometry encodes alternative views of the same object, which results in view-invariant learned descriptors. However, this requires a registered RGB-D dataset or a trained NeRF (neural radiance field), which is often highly laborious due to camera calibration, hardware setup and data logging. On the other hand, RGB image augmentation only requires an unordered set of RGB images, which maps the object(s) and can even be recorded with a smartphone. However, the descriptors learned from them cannot handle excessive changes in camera perspective and are therefore not always view-invariant, which limits their applicability.

According to various embodiments, an approach is provided for training a machine learning model for mapping camera images to descriptor images (e.g., a DON), which enables a simple approach to training data detection, i.e., a series of unordered RGB images, which in each case show one or more objects, is sufficient for training, but still allows the machine learning model to learn descriptors in a view-invariant manner; i.e., the descriptor determination by means of the machine learning model is more robust to changes in the camera perspective than in training methods based on RGB image augmentation.

According to various embodiments, a cycle correspondence loss (CCL) is used for this purpose. This is a loss for self-supervised training of a machine learning model for mapping camera images to descriptor images, which enables training based on selected (training image) pairs of training images (in particular RGB images). The idea behind this loss can be seen in the fact that for an image pair (I_{A}, I_{B}), given unique descriptors in the first (training) image I_{A}, any correct position prediction of a key point from image I_{A} (e.g., a certain object feature point, but also possibly a certain point in the background) in image Is can in turn be used to predict the (original) position of the key point in image I_{A}, as a result of which a cycle of correspondence predictions is created.

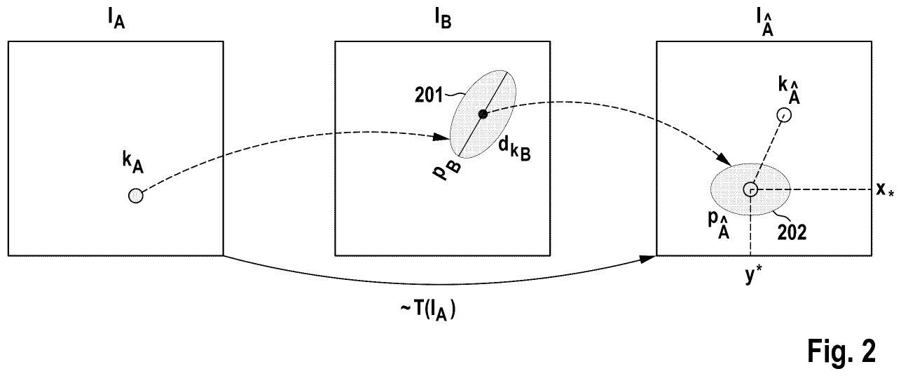

FIG. 2 illustrates a cycle of correspondence predictions for a key point k_{A}.

The key point k_{A} provides, via its descriptor (which the machine learning model assigns to it according to its current training status), an estimate 201 of the position of the key point in the image Is that (strictly speaking, an estimated descriptor value, see below) in turn provides an estimate 202 of the original position in the image I_{A} (or, in this exemplary embodiment, a transformed version thereof). That is, by transitioning from image I_{A} to I_{B} and back again (i.e., one cycle), one obtains an estimate of the original position of the key point. From this, a loss can be ascertained for this training image pair, which is smaller the better the estimate 202 corresponds to the original position. The machine learning model can then be adapted for reducing a (total) loss that includes these losses for a plurality of training image pairs (i.e., it is adapted in the direction of a decreasing gradient of the total loss, i.e., its parameters (typically weights) are changed in such a way that a renewed ascertainment of descriptor images to the training images of the training image pairs would yield a lower value for the total loss).

In this way, the machine model can independently learn to recognize valid correspondences without relying on correspondence annotations. Here, it is assumed that the set of training images largely maps the same content—but this can also comprise random object arrangements and different backgrounds.

For the following detailed description of the provided approach, it is assumed that two (training) images I_{A} and I_{B} (in this example I_{A} and I_{B}∈ [symbol] ^{3×H×W}, e.g., RGB images) and it is assumed that some pixels in image I_{A} have a corresponding pixel in image I_{B}. This assumption can be fulfilled, for example, by epipolar constraints.

With the aid of the machine learning model f_{θ}(·) (with its current training status, i.e., values of its parameters e corresponding to its current training status), each of the two images is mapped to a relevant descriptor image D_{A}, D_{B}∈ [symbol] ^{D×H×W} with descriptor values from a latent descriptor space. A key point or its pixel position in image I_{A} is designated as k_{A}=(x_{A}, y_{A}) and, if present, a corresponding pixel in image I_{B} (i.e., a pixel that corresponds to the same key point) as k_{B}=(x_{B}, y_{B}). x refers to the row coordinate and y to the column coordinate. Each key point k_{A} is assigned a corresponding descriptor dₖ_{_{A}}=D_{A}[x_{A}, y_{A}]∈ [symbol] ^{D} by D_{A}, and also the corresponding key point in I_{B} is assigned a descriptor dₖ_{_{B}}.

The CCL requires the capability of making a prediction about the position of a key point from one image in another image if its descriptor is given. The simplest method to find k_{B} if dₖ_{_{A}} is given is to determine the next descriptor in the latent space (i.e., descriptor space) in D_{B} with respect to dₖ_{_{A}}. While this is typically sufficient for inference (e.g., to determine the pose of an object in an image), the problem during training is that (x, y) coordinates are obtained in a non-differentiable way (so that a gradient descent method cannot be used).

Therefore, according to various embodiments, for determining the corresponding pixel, a distance heat map H^{k}^{_{A→B}} over D_{B} is initially ascertained by ascertaining the distance in pairs between dₖ_{_{A}}, and each descriptor of D_{B}, i.e.

$${H}_{xy}^{{k}_{A \to B}} = Δ ( {d}_{{k}_{A}} , {D}_{{B}_{xy}} ) \qquad ( 1 )$$

where Δ is a distance function, e.g., 12-norm, or a similarity measure such as cosine similarity. In the following, cosine similarity and normalized descriptors are assumed.

A probability distribution P(x, y|dₖ_{_{A}}, D_{B}) can now be determined by applying a temperature-scaled softmax function to the distance heat map, i.e.

$$P ( x , y \vert {d}_{{k}_{A}} , {D}_{B} ) = \frac{exp ( {H}_{xy}^{{k}_{A \to B}} / τ )}{{\sum }_{i = 1}^{H} {\sum }_{j = 1}^{W} exp ( {H}_{xy}^{{k}_{A \to B}} / τ )} \qquad ( 2 )$$

where t is the temperature. If the expected value of the marginal distributions is interpreted as coordinates, K_{B}=(x*, y*) can be estimated by

$${x}^{*} = {μ}_{x} = {\sum }_{i = 1}^{H} i \cdot {\sum }_{j = 1}^{W} P ( i , j \vert {d}_{{k}_{A}} , {D}_{B} ) \qquad ( 3 )$$

$${y}^{*} = {μ}_{y} = {\sum }_{i = 1}^{H} j \cdot {\sum }_{j = 1}^{W} P ( i , j \vert {d}_{{k}_{A}} , {D}_{B} ) \qquad ( 4 )$$

The relevant variances σₓ², σ_{y}² result accordingly as expected values over (x−μₓ)² or (y−μ_{y})². If ground truth annotations k_{B}⁽ⁱ⁾ (i is the key point index here) are present, e.g., for correspondence in pixels from the 3D geometry, it is simple to optimize the prediction error directly via the spatial expectation, e.g., with the loss function

$${ℒ}_{dist} , A \to B = {\sum }_{i}^{N} {‖ {k}_{B}^{★ ( i )} - {k}_{B}^{( i )} ‖}_{2} \qquad ( 5 )$$

According to various embodiments, the above concept is used for a fully self-supervised training method. This means that no fundamental truth k_{B}⁽ⁱ⁾ is given and an error to be optimized cannot be directly defined as in equation (5).

For the following explanation, the condition is temporarily assumed that for each (e.g., sampled) k_{A}⁽ⁱ⁾ there is a corresponding pixel k_{B}⁽ⁱ⁾ in I_{B}, even if this is unknown. Given this assumption, it is known that if the prediction is k_{B}*⁽ⁱ⁾ correct for the transition I_{A}→I_{B}, the associated descriptor d_{k*}_{_{B}}_{⁽ⁱ⁾} will provide a prediction k_{A}*⁽ⁱ⁾ through the transition I_{A}→I_{B}, so that k_{A}⁽ⁱ⁾≡k_{A}*⁽ⁱ⁾. Thus, one cycle of correspondence reconciliation would be completed.

Since K_{A}⁽ⁱ⁾ is known, the prediction error can be measured, which allows the error term of loss for the key point i to be defined as follows:

$${l}_{i} = ‖ {k}_{A}^{★ ( i )} - {k}_{A}^{( i )} ‖ \qquad ( 6 )$$

See also FIG. 2 for illustration.

Although the loss according to (6) is conceptually simple to formulate, some practical considerations must be taken into account. Below we discuss various steps that are necessary or helpful for training a model using the outlined approach.

Although k_{B}*⁽ⁱ⁾ has an associated descriptor, the simple indexing of the descriptor image based on the coordinates is not differentiable. In order to maintain differentiability, according to various embodiments, the expected value is calculated using the descriptors d̅ₖ_{_{B}} in a similar way as calculated for the spatial expected value according to (3) and (4):

$${\overline{d}}_{{k}_{B}} = {\sum }_{i = 1}^{H} {\sum }_{j = 1}^{W} \text{?} \cdot P ( i , j \vert {d}_{{k}_{A}} , {D}_{B} ) \qquad ( 7 )$$

$$\text{?} \text{indicates text missing or illegible when filed}$$

The point according to equations (3) and (4) can be considered as an estimate of the point to which the machine learning model would assign the descriptor according to (7).

If the descriptors are normalized, additional d̅ₖ_{_{B}} re normalized, which is assumed to be implicitly given here. While in this case the descriptors belong to the hypersphere manifold S^{D}, the averaging and normalization as described above leads to practically identical results for a trained network compared to the direct ascertainment of the expectation on the manifold. The distribution P(x, y|d̅ₖ_{_{B}}, D_{A}) for the transition I_{A}→I_{B} is defined by means of d̅ₖ_{_{B}} and k_{A}*⁽ⁱ⁾ is determined using the spatial expectation (according to equations (3) and (4)).

According to various embodiments, different augmentations are applied to the training images. For example, affine transformations (rotations, scalings), perspective distortions and color shifts—the latter primarily for brightness and augmentation—can be used. In order to ensure that the machine learning model does not ignore the image I_{B} and learns a kind of identity assignment via a shortcut, a copy I_{Â} of the input image I_{A} is generated (at least for a part of the training image pairs), both or at least one of the two (I_{Â} and I_{A}) are augmented and used as the first image of the training image pair or as the target image for the reverse direction. If the augmentations are known, then k_{Â}⁽ⁱ⁾, i.e., the position of k_{A}⁽ⁱ⁾ in I_{Â}, is also known.

This case is illustrated in FIG. 2: I_{A} and I_{Â} emerge from the same recorded camera image by (e.g., random in each case) augmentation; therefore, they are related to each other by a transformation T(I_{A}). I_{B} is another recorded camera image (which can also be augmented to increase the variety of training images), the content of which at least partially overlaps with I_{A} (and thus I_{Â}). The key point k_{A} is, e.g., a randomly sampled location in IA and the corresponding position k_{Â} in I_{Â} is ascertained according to the transformation. A corresponding point in I_{B} can but does not have to exist, but a potential correspondence can be ascertained or evaluated via a variance measure (χ, see below in connection with equation (8) (these variances can be superimposed on the training images, e.g., as a heat map, in order to make correspondences visible). Using the probability distribution according to equation (3) and the descriptor image of I_{B}, the expected descriptor d̅ₖ_{_{B}} can be calculated according to (7). Using this expected descriptor, the process can be reversed and the key point in I_{Â} can be estimated. The machine learning model is adapted to reduce the error between true position and estimate (e.g., summed or averaged over a batch of training image pairs).

When training with unordered RGB images, it can be expected not only that the backgrounds will vary from image to image, but also which objects are present in the images and in what orientation. According to various embodiments, the above assumption that each k_{A}⁽ⁱ⁾ has a counterpart in I_{B} is therefore relaxed. This results in two difficulties: First, any lᵢ (see equation (6)) for K_{A}⁽ⁱ⁾ without counterparts violates the (i) underlying assumption of cycle consistency, and calculated gradients could be completely counterproductive. Secondly, since d̅ₖ_{_{B}} is substantially a weighted sum of the descriptors that are most similar to dₖ_{_{A}}, the machine learning model could still theoretically find a path from k_{A}⁽ⁱ⁾to k*_{Â}⁽ⁱ⁾, even without a counterpart in I_{B}. This could lead to shortcut learning and is typically not desirable.

In order to root out and prevent such cases, according to various embodiments, the previously ascertained probability distributions (according to equation (2)) are exploited. For this purpose, the variance χi=σ_{x,i}²+σ_{y,i}² a prediction is calculated for the i-th key point. Intuitively, the variance is assumed to be small if a unique counterpart exists and the model is reliable. If there is no match or the model is not reliable, the variance should increase.

For example, variance is used in two ways. First, the q-quantile, e.g., q=15%, is formed via the summed variances for image IB and I_{Â} χi=χ_{Â,i}+χB,i of all N key points. This summed variance can be seen (for each training image pair and each key point) as a measure of the variance of the two position estimates in the two training images (in each case according to (3) and (4)). As a result, the q % of the most reliably recognized points are obtained, and only these are taken into account for loss calculation. Secondly, equation (6) is modified by scaling the contribution of each individual loss lᵢ with respect to the associated uncertainty, as a result of which the loss

$${ℒ}_{cyc} = {\sum }_{i}^{N} \frac{1}{1 + {χ}_{i}} ‖ \text{?} - \text{?} ‖ \qquad ( 8 )$$

$$\text{?} \text{indicates text missing or illegible when filed}$$

is obtained for the relevant training image pair, wherein one is added to the denominator in order to prevent the term from becoming prohibitively large if some χi are less than 1. It is important that the gradients of the variances be decoupled from the computational graph, since otherwise the model will simply learn to make predictions with low confidence instead of solving the prediction task.

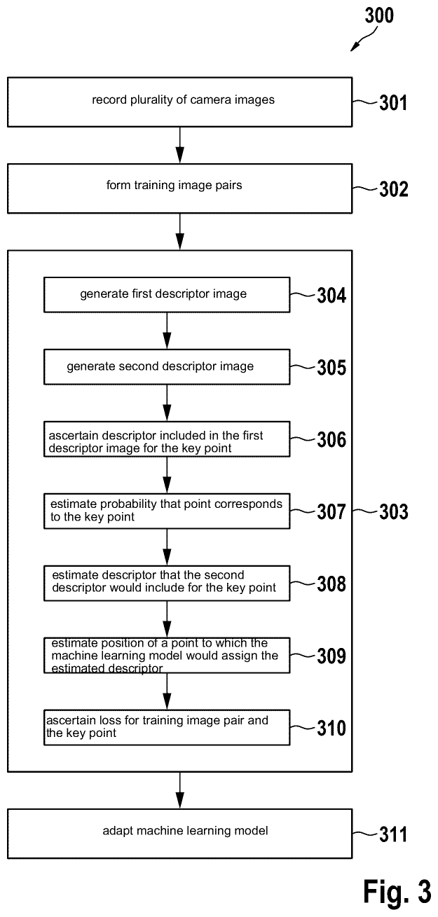

In summary, according to various embodiments, a method is provided as shown in FIG. 3.

FIG. 3 shows a flow chart 300 that illustrates a method for training a machine learning model for generating descriptor images to images showing one or more objects, according to one embodiment.

In 301, a plurality of camera images are recorded, wherein each camera image shows one or more objects.

In 302, training image pairs are formed from the plurality of camera images, wherein each training image pair comprises a first training image and a second training image.

In 303, for each training image pair and for each of one or more key points per training image pair (which is/are included in at least the relevant first training image)
in 304, a first descriptor image in generated for the first training image by feeding the first training image to the machine learning model (wherein the first descriptor image includes for each point of the first training image a relevant descriptor (which the machine learning model assigns to it based on the first training image));
in 305, a second descriptor image is generated for the second training image by feeding the second training image to the machine learning model (wherein the second descriptor image includes for each point of the second training image a relevant descriptor (which the machine learning model assigns to it based on the second training image));
in 306, the descriptor included in the first descriptor image is ascertained for the key point (e.g., object feature point or point in the background);
in 307, for each of the plurality of points of the second training image (e.g., all), a probability is estimated that the point corresponds to the key point (i.e., shows the same object feature point or point in the background), wherein the probability is estimated to be greater the closer the descriptor included in the first descriptor image for the key point is to the descriptor included in the second descriptor image for the relevant point of the second training image of the plurality of points of the second training image;
in 308, a descriptor is estimated that the second descriptor image would include for the key point (if it actually includes the estimated descriptor for one of the points, which is not necessarily the case), by weighted sum of the descriptors that the second descriptor image includes for the plurality of points of the second training image, wherein each descriptor is weighted by the probability ascertained for the point for which it is included in the second descriptor image;
in 309, the position of a point is estimated in the first training image or a transformed version of the first training image to which the machine learning model would assign the estimated descriptor (if it actually assigns the estimated descriptor for one of the points, which is not necessarily the case); and
in 310, a loss is ascertained for the training image pair and the key point from a distance between the position of the key point in the first training image or the transformed version of the first training image and the estimated position.

In 311, the machine learning model is adapted for reducing a total loss (e.g., batch loss) that includes the ascertained losses for at least a part of the training image pairs and key points.

The method of FIG. 3 can be carried out by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

By means of the trained machine learning model (e.g., by using the trained machine learning model to ascertain an object pose or ascertain locations to be processed), a control signal for a robot apparatus can ultimately be generated. Relevant locations of any type of object for which the machine learning model has been trained can be ascertained. The term “robot apparatus” may be understood to refer to any physical system, such as a computer-controlled machine, a vehicle, a household appliance, a power tool, a production machine, a personal assistant or an access control system. A control rule for the physical system is learned, and the physical system is then controlled accordingly.

For example, images are recorded by means of an RGB-D (color image plus depth) camera, processed by the trained machine learning model (e.g., neural network) and relevant locations in the working region of the robot apparatus are ascertained, wherein the robot apparatus is controlled depending on the ascertained locations. For example, an object (i.e., its position and/or pose) can be tracked in input sensor data. The descriptors can also be further processed in order to detect objects (and, for example, perform semantic segmentation), e.g., objects to be manipulated or traffic signs, road surfaces, pedestrians and vehicles.

The camera images are, for example, RGB images or RGB-D (color image plus depth) images, but can also be other types of camera images such as (only) depth images or thermal, video, radar, LiDAR, ultrasound, or motion images. Depth images are not strictly required. The output of the trained machine learning model can be used to ascertain object poses, for example to control a robot, e.g., to assemble a larger object from sub-objects, to move objects, etc. The approach of FIG. 3 can be used for any pose ascertainment method. From relevant locations ascertained from the descriptor images, it is possible to ascertain, e.g., the position of locations on an object where the object can be grasped (or even suctioned) by a robot and those where it should not be gripped. Thus, they provide valuable information for a manipulation task, for example.

What is claimed is:

1. A method for training a machine learning model for generating descriptor images for images showing one or more objects, the method comprising the following steps:
recording a plurality of camera images, wherein each camera image shows one or more objects;
forming training image pairs from the plurality of camera images, wherein each of the training image pairs includes a first training image and a second training image;
for each training image pair and for each of one or more key points per training image pair:
generating a first descriptor image for the first training image by feeding the first training image to the machine learning model,
generating a second descriptor image for the second training image by feeding the second training image to the machine learning model,
ascertaining a descriptor included in the first descriptor image for the key point,
estimating, for each plurality of points of the second training image, a probability that the point corresponds to the key point, wherein the probability is estimated to be greater the closer the descriptor included in the first descriptor image for the key point is to the descriptor included in the second descriptor image for the point of the second training image of the plurality of points of the second training image,
estimating a descriptor that the second descriptor image would include for the key point, by weighted sum of the descriptors that the second descriptor image includes for the plurality of points of the second training image, wherein each descriptor is weighted by the probability ascertained for the point for which it is included in the second descriptor image,
estimating a position of a point in the first training image or a transformed version of the first training image to which the machine learning model would assign the estimated descriptor, and
ascertaining a loss for the training image pair and the key point from a distance between a position of the key point in the first training image or the transformed version of the first training image and the estimated position; and
adapting the machine learning model for reducing a total loss that includes the ascertained losses for at least a part of the training image pairs and key points.

2. The method according to claim 1, wherein the position of the point in the first training image or in the transformed version of the first training image is estimated by estimating, for each of the plurality of points in the first training image or in the transformed version of the first training image, a probability that the point corresponds to a point to which the machine learning model would assign the estimated descriptor, wherein the probability is estimated to be greater the closer the estimated descriptor is to the descriptor that the machine learning model assigns to the relevant point of the plurality of points in the first training image or the transformed version of the first training image, and each coordinate of the position of the point is estimated as a weighted sum of values of the coordinates of the plurality of points in the first training image or the transformed version of the first training image, wherein each value of the coordinate is weighted with the probability ascertained for the point whose position it describes.

3. The method according to claim 1, wherein the total loss for each training image pair for which the loss is ascertained for each of a plurality of key points includes the losses ascertained for the key points as a weighted sum, wherein each ascertained loss is weighted less the greater a measure of the variance of the estimate of the position of the point in the first training image or in the transformed version of the first training image to which the machine learning model would assign the estimated descriptor and/or the estimate of the position of the point in the second training image to which the machine learning model would assign the estimated descriptor is when ascertaining the loss for the relevant key point.

4. The method according to claim 3, wherein the ascertained loss in the total loss is weighted with zero when a measure of variance is above a threshold value.

5. The method according to claim 1, wherein: (i) the transformed version of the first training image is generated by an augmentation of the first training image, or (ii) the forming of at least some of the training image pairs includes that the first training image is generated by augmenting a relevant recorded camera image and wherein the transformed version of the first training image is generated by another augmentation of the relevant recorded camera image.

6. The method according to claim 1, wherein the machine learning model is a neural network.

7. A method for controlling a robot for recording or processing an object, the method comprising the following steps:
training a machine learning model for generating descriptor images for images showing one or more objects, including:
recording a plurality of camera images, wherein each camera image shows one or more objects;
forming training image pairs from the plurality of camera images, wherein each of the training image pairs includes a first training image and a second training image;
for each training image pair and for each of one or more key points per training image pair:
generating a first descriptor image for the first training image by feeding the first training image to the machine learning model,
generating a second descriptor image for the second training image by feeding the second training image to the machine learning model,
ascertaining a descriptor included in the first descriptor image for the key point,
estimating, for each plurality of points of the second training image, a probability that the point corresponds to the key point, wherein the probability is estimated to be greater the closer the descriptor included in the first descriptor image for the key point is to the descriptor included in the second descriptor image for the point of the second training image of the plurality of points of the second training image,
estimating a descriptor that the second descriptor image would include for the key point, by weighted sum of the descriptors that the second descriptor image includes for the plurality of points of the second training image, wherein each descriptor is weighted by the probability ascertained for the point for which it is included in the second descriptor image,
estimating a position of a point in the first training image or a transformed version of the first training image to which the machine learning model would assign the estimated descriptor, and
ascertaining a loss for the training image pair and the key point from a distance between a position of the key point in the first training image or the transformed version of the first training image and the estimated position; and
adapting the machine learning model for reducing a total loss that includes the ascertained losses for at least a part of the training image pairs and key points;
recording a camera image that shows the object in a current control scenario;
feeding the camera image to the machine learning model for generating a descriptor image;
ascertaining a position of a location for recording or processing the object in the current control scenario from the descriptor image; and
controlling the robot according to the ascertained position.

8. The method according to claim 7, further comprising:
identifying a reference location in a reference image;
ascertaining a descriptor of the identified reference location by feeding the reference image to the machine learning model;
ascertaining a position of the reference location in the current control scenario by searching for the ascertained descriptor in the descriptor image generated from the camera image; and
ascertaining the position of the location for recording or processing the object in the current control scenario from the ascertained position of the reference location.

9. A control device configured to train a machine learning model for generating descriptor images for images showing one or more objects, the control device configured to:
record a plurality of camera images, wherein each camera image shows one or more objects;
form training image pairs from the plurality of camera images, wherein each of the training image pairs includes a first training image and a second training image;
for each training image pair and for each of one or more key points per training image pair:
generate a first descriptor image for the first training image by feeding the first training image to the machine learning model,
generate a second descriptor image for the second training image by feeding the second training image to the machine learning model,
ascertain a descriptor included in the first descriptor image for the key point,
estimate, for each plurality of points of the second training image, a probability that the point corresponds to the key point, wherein the probability is estimated to be greater the closer the descriptor included in the first descriptor image for the key point is to the descriptor included in the second descriptor image for the point of the second training image of the plurality of points of the second training image,
estimate a descriptor that the second descriptor image would include for the key point, by weighted sum of the descriptors that the second descriptor image includes for the plurality of points of the second training image, wherein each descriptor is weighted by the probability ascertained for the point for which it is included in the second descriptor image,
estimate a position of a point in the first training image or a transformed version of the first training image to which the machine learning model would assign the estimated descriptor, and
ascertain a loss for the training image pair and the key point from a distance between a position of the key point in the first training image or the transformed version of the first training image and the estimated position; and
adapt the machine learning model for reducing a total loss that includes the ascertained losses for at least a part of the training image pairs and key points.

10. A non-transitory computer-readable medium on which are stored commands training a machine learning model for generating descriptor images for images showing one or more objects, the commands, when executed by a processor, causing the processor to perform the following steps:
recording a plurality of camera images, wherein each camera image shows one or more objects;
forming training image pairs from the plurality of camera images, wherein each of the training image pairs includes a first training image and a second training image;
for each training image pair and for each of one or more key points per training image pair:
generating a first descriptor image for the first training image by feeding the first training image to the machine learning model,
generating a second descriptor image for the second training image by feeding the second training image to the machine learning model,
ascertaining a descriptor included in the first descriptor image for the key point,
estimating, for each plurality of points of the second training image, a probability that the point corresponds to the key point, wherein the probability is estimated to be greater the closer the descriptor included in the first descriptor image for the key point is to the descriptor included in the second descriptor image for the point of the second training image of the plurality of points of the second training image,
estimating a descriptor that the second descriptor image would include for the key point, by weighted sum of the descriptors that the second descriptor image includes for the plurality of points of the second training image, wherein each descriptor is weighted by the probability ascertained for the point for which it is included in the second descriptor image,
estimating a position of a point in the first training image or a transformed version of the first training image to which the machine learning model would assign the estimated descriptor, and
ascertaining a loss for the training image pair and the key point from a distance between a position of the key point in the first training image or the transformed version of the first training image and the estimated position; and
adapting the machine learning model for reducing a total loss that includes the ascertained losses for at least a part of the training image pairs and key points.
